(19) United States
(12) Patent Application Publication
(10) Pub. No.: US 2015/0147635 A1
(43) Pub. Date: May 28, 2015

(54) SECONDARY BATTERY

(71) Applicant: SAMSUNG SDI CO., LTD., Yongin-si (KR)

(72) Inventors: Jeongchull AHN, Yongin-si (KR); Seongja NOH, Yongin-si (KR)

(73) Assignee: SAMSUNG SDI CO., LTD., Yongin-si (KR)

(21) Appl. No.: 14/250,960

(22) Filed: Apr. 11, 2014

(30) Foreign Application Priority Data
Nov. 22, 2013 (KR) 10-2013-0143211

(51) Int. Cl. H01M 2/06

(52) U.S. Cl. CPC H01M 2/06
USPC 429/179; 429/163

(57) ABSTRACT

A secondary battery includes an electrode assembly, the electrode assembly having first and second electrode plates and a separator therebetween, a case accommodating the electrode assembly, and first and second electrode tabs respectively connected to the first and second electrode plates, the first electrode tab being formed of an aluminum alloy including 97 wt % to 98.5 wt % of aluminum (Al), 1 wt % to 3 wt % of iron (Fe), and 0 wt % to less than 1 wt % of an impurity.

### CROSS-REFERENCE TO RELATED APPLICATION

Korean Patent Application No. 10-2013-0143211, filed on Nov. 22, 2013, in the Korean Intellectual Property Office, and entitled: “SECONDARY BATTERY,” is incorporated by reference herein in its entirety.

### BACKGROUND

1. Field

Embodiments relate to a secondary battery.

2. Description of the Related Art

Secondary batteries are chargeable and dischargeable. Low capacity batteries that use single battery cells may be used as power sources for various small portable electronic devices such as cellular phones, camcorders, or the like. High power batteries, which may use, e.g., tens of battery cells connected to each other in a battery pack, may be used as power sources for motor drive, such as in electric scooters, hybrid electric vehicles, or the like.

In general, an electronic device, such as a notebook computer, a mini notebook computer, a net book, a mobile computer, an ultra mobile personal computer (UMPC) or a portable multimedia player (PMP), uses a battery pack as a portable power source, and the battery pack may have a plurality of battery cells connected in series and/or in parallel. The battery pack may include a protective circuit module (PCM) for protecting battery cells against over-charge, over-discharge, or over-current. The protective circuit module may be housed in a frame with the battery cells and may be welded to the electrode tabs.

Depending on the external shape, secondary batteries may be classified into different types, for example, a cylindrical battery using a cylindrical aluminum can, a prismatic battery using a prismatic aluminum can, and a pouch type battery accommodated in a thin-plate pouch type case. When they are used for motor drive of the machines requiring a high power source such as the hybrid electric vehicles, the secondary batteries (or unit battery) may form a secondary battery module of high power.

### SUMMARY

Embodiments are directed to a secondary battery including an electrode assembly, the electrode assembly having first and second electrode plates and a separator therebetween, a case accommodating the electrode assembly, and first and second electrode tabs connected to the first and second electrode plates, the first electrode tab being formed of an aluminum alloy including 97 to 98.5 wt % of aluminum (Al), 1 to 3 wt % of iron (Fe), and 0 wt % to less than 1 wt % of an impurity.

The aluminum alloy may contain aluminum (Al) in an amount of 97 wt % to 98 wt %.

The impurity may be one selected from silicon (Si) and copper (Cu).

The aluminum alloy may contain silicon (Si) in an amount of less than 0.15 wt %.

The aluminum alloy may contain copper (Cu) in an amount of less than 0.05 wt %.

The aluminum alloy may have a grain size in a range of 5 to 10 μm.

The aluminum alloy may have a tensile strength in a range of 80 to 110 N/mm².

The aluminum alloy may have an elongation in a range of 17 to 38%.

The aluminum alloy may be bendable up to 13 to 30 times when it is bent 180 degrees.

The aluminum alloy may have an electrical conductivity in a range of 50 to 65% IACS, as defined by the international annealed copper standard (IACS).

The aluminum alloy may have resistance in a range of 68 to 85 Ω/Km.

The first electrode tab may extend outside the case.

The case may be a pouch, and the first electrode tab may be attached, at a location inside of the pouch, to the first electrode plate and may extend through a sealing portion of the pouch to the outside of the pouch.

The first electrode tab may serve as a terminal at an outside of the case.

### BRIEF DESCRIPTION OF THE DRAWINGS

Features will become apparent to those of skill in the art by describing in detail exemplary embodiments with reference to the attached drawings in which:

FIG. 1 illustrates an exploded perspective view of a secondary battery according to an example embodiment;

FIGS. 2a and 2b illustrate observation results of grain sizes of aluminum alloys used in first electrode tabs of secondary batteries according to Example 1 and Comparative Examples 1 and 2, as shown in Table 1; and

FIGS. 3a and 3b illustrate observation results of aluminum alloys used in first electrode tabs of secondary batteries according to Example 1 and Comparative Examples 1 and 2, as shown in Table 1.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. In the drawing figures, the dimensions of layers and regions may be exaggerated for clarity of illustration. Like reference numerals refer to like elements throughout.

As used herein, the term “and/or” includes any and all combinations of one or more of the associated listed items.

The terminology used herein is for the purpose of describing particular embodiments and is not intended to be limiting of the embodiments. As used herein, singular forms are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms “first,” “second,” etc. may be used herein to describe various members, elements, regions, layers, and/or parts, these members, elements, regions, layers, and/or parts should not be limited by these terms. These terms are merely used to distinguish one member, element, region, layer, and/or part from another member, element, region, layer, and/or part. Thus, for example, a first member, element, region, layer, and/or part discussed below could be termed a second member, element, region, layer, and/or part.

Hereinafter, a configuration of a secondary battery according to an example embodiment will be described.

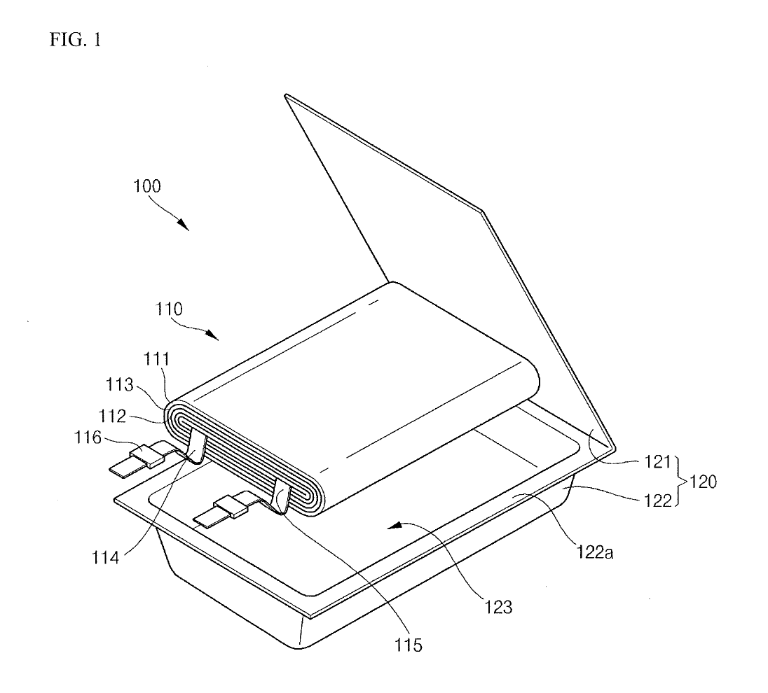

FIG. 1 is an exploded perspective view of a secondary battery (100) according to an example embodiment.

Referring to FIG. 1, the secondary battery 100 according to an example embodiment may include an electrode assembly 110 and a case 120 accommodating the electrode assembly 110.

In the present example embodiment, the electrode assembly 110 is formed by stacking or winding a first electrode plate 111, a second electrode plate 112, and a separator 113 interposed between the first electrode plate 111 and the second electrode plate 112. The first electrode plate 111 may be a positive electrode and the second electrode plate 112 may be a negative electrode, or vice versa.

When the first electrode plate 111 is a positive electrode plate, it may be formed by coating a first active material layer on both surfaces of a first current collector made of a metal thin plate having good conductivity, such as an aluminum (Al) foil. A chalcogenide compound may be used as the first active material, and examples thereof may include, e.g., composite metal oxides, such as LiCoO₂, LiMn₂O₄, LiNiO₂, or LiNiMnO₂.

According to the present example embodiment, the first electrode tab 114 is formed on a first uncoated portion of the first electrode plate 111 without a first active material layer formed thereon. For example, one end of the first electrode tab 114 may be electrically connected to the first uncoated portion and the other end of the first electrode tab 114 may be drawn to the outside of the case 120.

According to the present example embodiment, the first electrode tab 114 may be formed of an aluminum alloy including 97 to 98.5 wt % of aluminum (Al), 1 to 3 wt % of iron (Fe), and 0 wt % to less than 1 wt % of impurity. The aluminum (Al) may be contained in an amount of 97 to 98 wt %. The impurity may include less than 0.15 wt % of silicon (Si) and less than 0.05 wt % of copper (Cu).

According to the present example embodiment, the first electrode tab 114 may exhibit improved elongation and tensile strength, which may help secure stability during free fall of the secondary battery.

An insulating tape 116 for insulation may be attached to a region contacting the case 120 of the first electrode tab 114. The insulating tape 116 may include, e.g., polyphenylene sulfide (PPS), polyimide (PI), polypropylene (PP), etc.

When the second electrode plate 112 is a negative electrode, it may be formed by coating a second active material layer on both surfaces of a second current collector made of a conductive metal thin plate, such as a copper (Cu) or nickel (Ni) foil. A carbon-based material, Si, Sn, tin oxide, a tin alloy compound, a transition metal oxide, lithium metal nitride, metal oxide, etc., may be used as the second active material.

According to the present example embodiment, the second electrode tab 115 is formed on a second uncoated portion of the second electrode plate 112 without a second active material layer formed thereon. For example, one end of the second electrode tab 115 may be electrically connected to the first uncoated portion and the other end of the second electrode tab 115 may be drawn to the outside of the case 120.

According to the present example embodiment, the second electrode tab 115 may be formed of a nickel (Ni) alloy. The insulating tape 116 for insulation maybe attached to a region contacting the case 120 of the second electrode tab 115.

According to the present example embodiment, the separator 113 is interposed between the first electrode plate 111 and the second electrode plate 112 in order to prevent a short-circuit between the first and second electrode plates 111 and 112. The separator 113 may include, e.g., one or more of polyethylene, polypropylene, or a copolymer of polyethylene and polypropylene. The separator 113 may have a width larger than that of the first or second electrode plate 111, 112 to prevent the short-circuit between the first and second electrode plates 111 and 112.

According to the present example embodiment, the case 120 includes an upper case 121 and a lower case 122 produced by bending a mid portion of one side of an integrally formed rectangular pouch film in a lengthwise direction. A groove 123 in which the electrode assembly 110 is to be received is formed in the lower case 122 by pressing, and a sealing part 122a to be sealed with the upper case 121 is formed in the lower case 122.

According to an example embodiment, the secondary battery 100 employs an aluminum alloy including 97 to 98.5 wt % of aluminum (Al), 1 to 3 wt % of iron (Fe), and less than 1 wt % of impurity as a material of the electrode tab 114. The electrode tab 114 of the secondary battery 100 may have improved tensile strength and elongation, which may help secure stability and reliability of the secondary battery during free fall.

Physical properties of the aluminum alloy used in the first electrode tab 114 were tested. Table 1 shows compositions of aluminum alloys used in the first electrode tabs according to Example 1 and Comparative Examples 1 and 2 (units: wt %)

TABLE 1

| | Si | Fe | Cu | Mn | Mg | Zn | Al |
|---|---|---|---|---|---|---|---|
| Example 1 | ≦0.15 | 1-3 | ≦0.05 | — | — | — | 97-98.5 |

| | | | | | | |
|---|---|---|---|---|---|---|
| Comparative | ≦0.7 | ≦0.1 | ≦0.05 | ≦0.05 | ≦0.1 | ≧99.3 |
| Example 1 | | | | | | |
| Comparative | ≦0.7 | ≦0.05 | ≦0.05 | ≦0.05 | ≦0.1 | ≧99.3 |
| Example 2 | | | | | | |

Grain sizes, tensile strengths, elongation rates, and falling test results will now be described with reference to Example 1 and Comparative Examples 1 and 2, as shown in Table 1.

Grain Sizes and Surface States after Bending

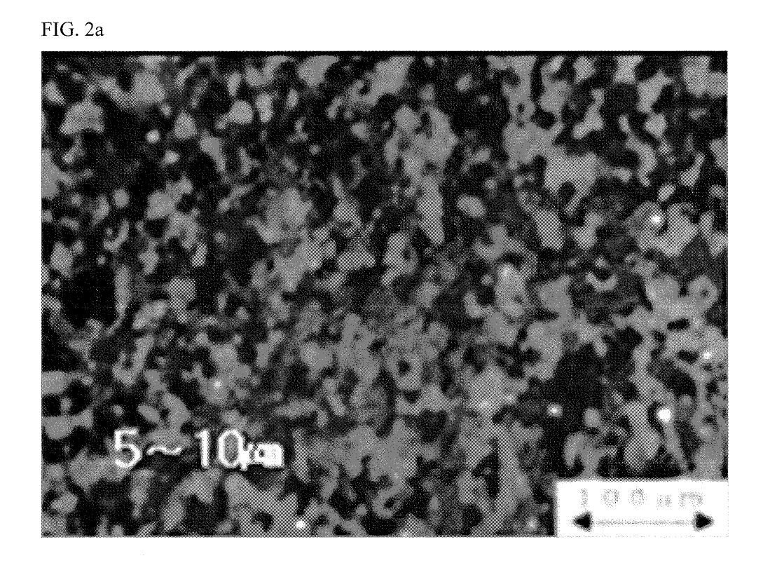

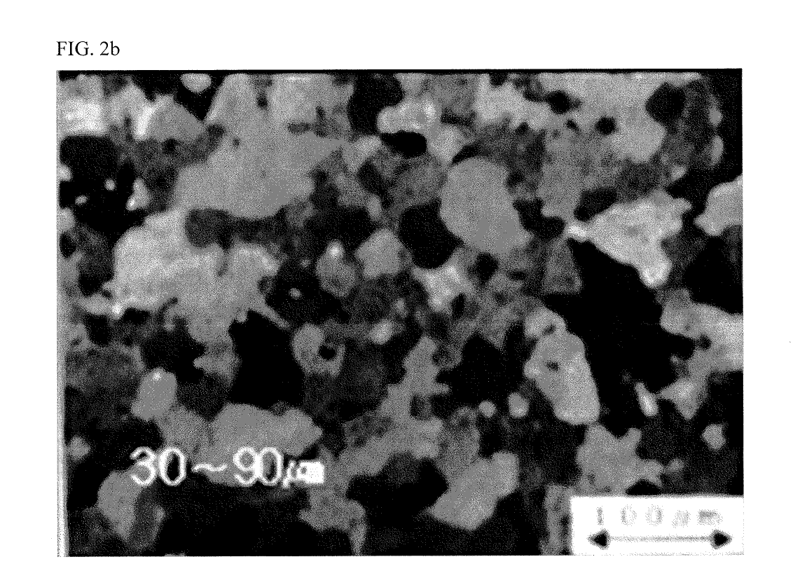

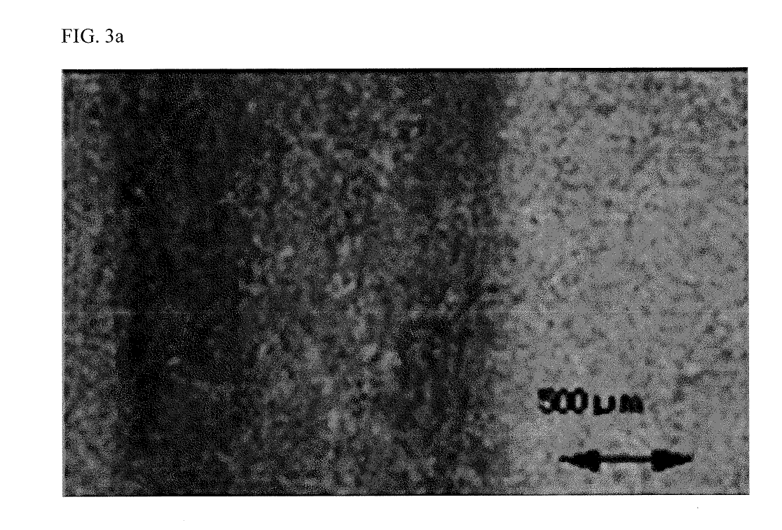

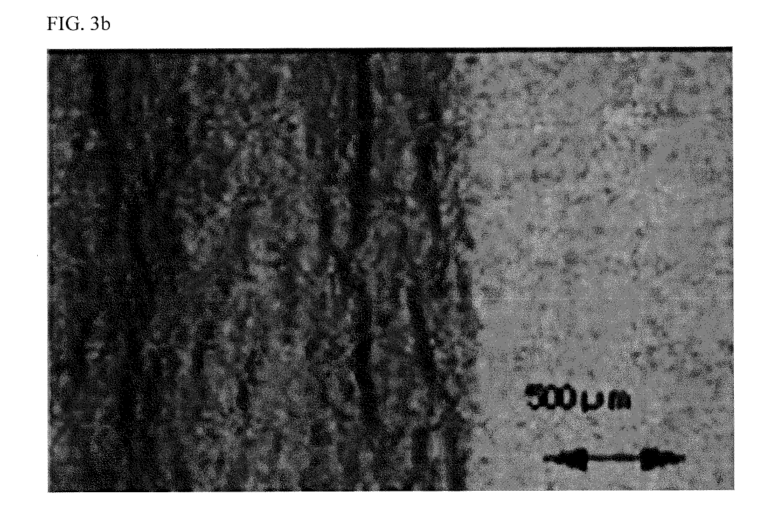

FIGS. 2a and 2b illustrate observation results of grain sizes of aluminum alloys used in first electrode tabs of secondary batteries according to Example 1 and Comparative Examples 1 and 2, as shown in Table 1, and FIGS. 3a and 3b illustrate observation results of aluminum alloys used in first electrode tabs of secondary batteries according to Example 1 and Comparative Examples 1 and 2, as shown in Table 1.

FIGS. 2a and 3a show observation results of grain sizes and surface states in Example 1, and FIGS. 2b and 3b show observation results of grain sizes and surface states in Comparative Example 1. The grain sizes and surface states in Example 1 and Comparative Example 1 were observed by high-resolution scanning electron microscopy (SEM).

Referring to FIGS. 2a and 2b, the grain sizes in Example 1 were smaller than those in Comparative Example 1. The grain sizes in Example 1 were in the range of 5 to 10 μm, and the grain sizes in Comparative Example 1 were in the range of 30 to 90 μm. Without being bound by theory, it is believed that the aluminum alloy having relatively small grain sizes was superior in bendability, and demonstrated high stability against free fall or external impacts.

Referring to FIGS. 3a and 3b, in terms of surface states after bending, the aluminum alloy of Example 1 had a smoother surface than the aluminum alloy of Comparative Example 1. Without being bound by theory, it believed that cracks were generated on the aluminum alloy of Comparative Example 1.

Tensile Strength and Elongation

Table 2 shows measuring results of tensile strengths and elongation rates in Example 1 and Comparative Example 1, as shown in Table 1. Here, test pieces used in Example 1 and Comparative Example 1 had a length of 200 mm. For each, 25 test pieces having composition ratios of Example 1 and Comparative Example 1 were used. The tensile strength was measured using a tensile strength measuring device (Model name: RTC-1210 manufactured by Orientec, Co., Ltd.), Here, the tension speed was 50 mm/min and gauge length of test pieces were 100 mm. Assuming that the gauge length was 100 mm is denoted by reference symbol A and a ruptured gauge length when the test piece was extended is denoted by reference symbol A′, the elongation can be defined in Equation (1):

Elongation (%)={(A′−A)/A}×100 (1)

TABLE 2

| | Tensile strength (N/mm²) | | Elongation (%) | |
|---|---|---|---|---|
| | Com- | | Com- | |
| | par- | | par- | |
| | ative | | ative | |
| | Exam- | Exam- | Exam- | Exam- |
| N = 25 | ple 1 | ple 1 | ple 1 | ple 1 |
| 1 | 74.1 | 94.9 | 17.8 | 26.2 |
| 2 | 74.8 | 96.6 | 20.4 | 24.8 |
| 3 | 73.5 | 95.7 | 17.8 | 26.4 |
| 4 | 74.4 | 97.7 | 16.5 | 26.8 |
| 5 | 74.8 | 94.9 | 17 | 20.2 |
| 6 | 72.6 | 96.2 | 14.5 | 24.8 |
| 7 | 72.4 | 97.7 | 15.5 | 25 |
| 8 | 74.6 | 96.3 | 16.6 | 23.6 |
| 9 | 74.4 | 97.3 | 19.1 | 24 |
| 10 | 73.1 | 95.2 | 18.9 | 28.3 |
| 11 | 74 | 95.6 | 18.7 | 25 |
| 12 | 73.4 | 94.9 | 19.8 | 23.6 |
| 13 | 73.4 | 94.9 | 19.4 | 26.3 |
| 14 | 73.8 | 94.7 | 18.7 | 25.2 |
| 15 | 73.7 | 96.9 | 17.2 | 19.9 |
| 16 | 73.9 | 94.3 | 17.9 | 26.8 |
| 17 | 73.7 | 94.8 | 18.3 | 26.3 |
| 18 | 74.4 | 95.2 | 18.5 | 25.5 |
| 19 | 73.3 | 98.4 | 14.6 | 24.5 |
| 20 | 72.7 | 94.4 | 16.5 | 22.2 |
| 21 | 73.2 | 95 | 16.8 | 23.2 |
| 22 | 73.1 | 95.4 | 18.4 | 24 |
| 23 | 72.5 | 95 | 15 | 24.8 |
| 24 | 74.5 | 94.7 | 19.4 | 24.5 |
| 25 | 73 | 95.2 | 17.7 | 25.3 |
| Maximum | 74.8 | 98.4 | 20.4 | 28.3 |
| value | | | | |
| Minimum | 72.4 | 94.3 | 14.5 | 19.9 |
| value | | | | |
| Mean | 73.625 | 95.676 | 17.64 | 24.688 |

Referring to Table 2, the electrode tabs of Example 1 demonstrated 95.676 N/mm² in mean value of tensile strength, which was superior to the mean value of tensile strength of the electrode tabs of Comparative Example 1, that is, 73.625 N/mm². In addition, the electrode tabs of Example 1 demonstrated 24.688% in mean value of elongation, which was superior to the mean value of elongation of the electrode tabs of Comparative Example 1, that is, 17.64%. Accordingly, the electrode tabs according to Example 1 may provide excellent tensile strength and elongation, which may help secure stability and reliability of the secondary battery, and may not easily be ruptured free fall or external impacts.

Free Fall Test

Tables 3a and 3b show free fall test results of secondary batteries employing first electrode tabs having composition ratios of Example 1 and Comparative Examples 1 and 2.

Soft tabs 1, 2, 3, 4, and 5 had a composition ratio of Example 1 shown in Table 1, and hard tabs 1, 2, 3, 4, and 5 had a composition ratio of one of Comparative Examples 1 and 2 shown in Table 1.

The free fall tests were carried out after exposing the secondary batteries employing the respective electrode tabs under high-temperature, high-humidity conditions of 60° C., and 90% RH for 72 hours. Tables 3a and 3b show initial open circuit voltages (OCVs) measured after exposing the secondary batteries under high-temperature, high-humidity conditions for 72 hours, and OCVs measured by allowing the secondary batteries to fall step by step and measuring whenever the falling was completed. The falling steps were carried out a total of 7000 counts of falling steps as follows: (1) 1250 counts on front surfaces; (2) 1250 counts on rear surfaces; (3) 750 counts on left sides; (4) 750 counts on right sides; (5) 250 counts on bottom sides; (6) 500 counts on bottom sides; (7) 750 counts on bottom sides; (8) 250 counts on top sides; (9) 500 counts on top sides; and (10) 750 counts on top sides. It was determined whether a secondary battery was defective or not by checking whether it had a normal voltage by comparing the initial OCV and an OCV measured after each falling step. Thus, the initial OCV was compared with the OCV for each falling step carried out on each secondary battery, and if the secondary battery had a constant voltage, it was determined that the secondary battery was normal. However, if there was a change in the voltage of the secondary battery, the first electrode tab of the secondary battery was expected to be cut, and it was determined that the secondary battery was defective.

TABLE 3a

| Steps | Initial | | | | | |
|---|---|---|---|---|---|---|
| (Accumulated | OCV | (1) | (2) | (3) | (4) | (5) |
| counts) | (0) | (1250) | (2500) | (3250) | (4000) | (4250) |
| Soft tab 1 | 3.8392 | 3.8393 | 3.8393 | 3.8391 | 3.8392 | 3.8392 |
| Soft tab 2 | 3.8396 | 3.8397 | 3.8397 | 3.8396 | 3.8396 | 3.8396 |
| Soft tab 3 | 3.8395 | 3.8396 | 3.8395 | 3.8395 | 3.8395 | 3.8394 |
| Soft tab 4 | 3.8402 | 3.8403 | 3.8403 | 3.8402 | 3.8402 | 3.8402 |
| Soft tab 5 | 3.8389 | 3.8391 | 3.8391 | 3.839 | 3.839 | 3.8399 |
| Hard tab 1 | 3.8409 | 3.8409 | 3.8409 | 3.8409 | 3.8408 | 3.8408 |
| Hard tab 2 | 3.8431 | 3.8431 | 3.8431 | 3.8431 | 3.8431 | 3.8431 |
| Hard tab 3 | 3.8439 | 3.8438 | 3.8438 | 3.8438 | 3.8438 | 3.8438 |
| Hard tab 4 | 3.8454 | 3.8454 | 3.8454 | 3.8453 | 3.8453 | 3.8453 |
| Hard tab 5 | 3.8424 | 3.8423 | 3.8423 | 3.8423 | 3.8422 | 3.8422 |

TABLE 3b

| Steps | | | | | | |
|---|---|---|---|---|---|---|
| (Accumulated | (6) | (7) | (8) | (9) | (10) | |
| counts) | (4750) | (5500) | (5750) | (6250) | (7000) | Results |
| Soft tab 1 | 3.8391 | 3.8391 | 3.8391 | 3.8391 | 3.8391 | OK |
| Soft tab 2 | 3.8395 | 3.8395 | 3.8395 | 3.8395 | 3.8395 | OK |
| Soft tab 3 | 3.8394 | 3.8394 | 3.8394 | 3.8394 | 0.7377 | NG |
| | | | | | (NG) | |
| Soft tab 4 | 3.8401 | 3.8401 | 3.8402 | 3.8402 | 3.8402 | OK |
| Soft tab 5 | 3.8389 | 3.8389 | 3.8389 | 3.8389 | 3.8389 | OK |
| Hard tab 1 | 3.8408 | 0.8556 | — | — | — | NG |
| | | (NG) | | | | |
| Hard tab 2 | 3.843 | 0.9182 | — | — | — | NG |
| | | (NG) | | | | |
| Hard tab 3 | 3.8438 | 3.8438 | 3.8437 | 3.8437 | 3.8438 | OK |
| Hard tab 4 | 3.8453 | 0.7505 | — | — | — | NG |
| | | (NG) | | | | |
| Hard tab 5 | 0.732 | — | — | — | — | NG |
| | (NG) | | | | | |

Referring to Tables 3a and 3b, secondary batteries employing soft tabs 1, 2, 3, 4, and 5 demonstrated relatively constant voltages up to 5500 counts of falling steps, suggesting that they were in relatively good states, while secondary batteries employing hard tabs 1, 2, 4, and 5 demonstrated sharp voltage drops after 5500 counts of falling steps, suggesting that they were defective. In particular, it was confirmed that defects occurred to the secondary battery employing the hard tab 5 after 4750 counts of falling steps, suggesting that the secondary battery employing the hard tabs was brittle against the free fall. In addition, for up to 7000 counts of falling steps, most secondary batteries having composition ratios of Example 1 (except for the secondary battery employing the soft tab 3 determined as being defective) had superior properties. In contrast, the secondary batteries employing hard tabs 1, 2, 4, and 5 were determined to be defective.

Physical Properties of Note

Table 4 shows physical properties of note for aluminum alloys according to Example 1 and Comparative Example 1 shown in Table 1. Here, the bendability is indicated by the maximum number of bending counts without being ruptured when the electrode tabs according to Example 1 and Comparative Example 1 were bent 180 degrees. In addition, the electrical conductivity is defined in percentile by the International Annealed Copper Standard (IACS), assuming that the conductivity of pure copper (1.73×10⁻⁸ Ωm) is set to 100% IACS.

TABLE 4

| | Tensile | | | Electrical | Resis- |
|---|---|---|---|---|---|
| | strength | Elongation | Bendability | conductivity | tance |
| | (N/mm²) | (%) | (Times) | (% IACS) | (Ω/Km) |
| Example 1 | 90-100 | 20-28 | 16-20 | 55-60 | 73-77 |
| Comparative | 70-80 | 15-23 | 10-14 | 59-61 | 75-78 |
| Example 1 | | | | | |

Referring to Table 4, the electrode tabs of Example 1 demonstrated 50 to 65% IACS, more particularly 55 to 60% IACS, in electrical conductivity, which was a similar level to the electrical conductivity of the electrode tabs of Comparative Example 1, that is, 59 to 61% IACS. In addition, the electrode tabs of Example 1 demonstrated 68 to 85 Ω/Km, more particularly 73 to 77 Ω/Km, in resistance, which was a similar level as the resistance of the electrode tabs of Comparative Example 1, that is, 75 to 78 Ω/Km. In view of elongation, the electrode tabs of Example 1 demonstrated 80 to 110 N/mm² in tensile strength and 17 to 38% in elongation, more particularly 90 to 100 N/mm² in tensile strength and 20 to 28% in elongation, which were superior to the tensile strength and elongation of the electrode tabs of Comparative Example 1, that is, 70 to 80 N/mm² and 15 to 23%, respectively. In addition, in Example 1, the electrode tabs were bendable 13 to 30 times, more particularly 16 to 20 times, when they were bent 180 degrees, suggesting that the electrode tabs of Example 1 were superior to the electrode tabs of Comparative Example 1, which were bendable 10 to 14 times, in view of bendability. The electrode tabs of Example 1 were made of soft materials, compared to the electrode tabs of Comparative Example 1, and demonstrated flexibility without being cut during free fall tests of the secondary batteries, which may help secure the stability and reliability of secondary battery.

By way of summation and review, a secondary battery may be constructed by accommodating an electrode assembly (which may be formed by inserting a separator as an insulator between positive and negative electrode plates) in a case together with an electrolytic solution. Electrode tabs may be used as terminal portions of positive and negative electrodes, and may be connected to the positive and negative electrode plates to then be drawn to the outside of the case. During a falling test (for determining reliability of the secondary battery), the electrode tabs, e.g., the positive electrode tab, may be cut at a boundary region between the case and the positive electrode tab, which may make it difficult to use electrode tabs as terminal portions.

As described above, embodiments may provide a secondary battery, which may include an electrode tab formed of a material that improves tensile strength and elongation. The secondary battery may be stable when subjected to a free fall.

As described above, the secondary battery according to embodiments may improve a tensile strength and an elongation rate by forming a positive electrode tab using an aluminum alloy including 97 to 98.5 wt % of aluminum (Al), 1 to 3 wt % of iron (Fe) and less than 1 wt % of impurity, which may help secure stability during free fall.

As described above, the secondary battery 100 according to an example embodiment employs an aluminum alloy including 97 to 98.5 wt % of aluminum (Al), 1 to 3 wt % of iron (Fe) and less than 1 wt % of impurity as the first electrode tab 114. In a secondary battery using an electrode tab having excellent tensile strength, elongation and bendability, it may be possible to prevent the electrode tab from being cut during free fall, which may help secure stability and reliability of the secondary battery.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
an electrode assembly, the electrode assembly having first and second electrode plates and a separator therebetween;
a case accommodating the electrode assembly; and
first and second electrode tabs respectively connected to the first and second electrode plates, the first electrode tab being formed of an aluminum alloy including 97 wt % to 98.5 wt % of aluminum (Al), 1 wt % to 3 wt % of iron (Fe), and 0 wt % to less than 1 wt % of an impurity.

2. The secondary battery as claimed in claim 1, wherein the aluminum alloy contains aluminum (Al) in an amount of 97 wt % to 98 wt %.

3. The secondary battery as claimed in claim 1, wherein the impurity is one selected from silicon (Si) and copper (Cu).

4. The secondary battery as claimed in claim 3, wherein aluminum alloy contains silicon (Si) in an amount of 0 wt % to less than 0.15 wt %.

5. The secondary battery as claimed in claim 3, wherein aluminum alloy contains copper (Cu) in an amount of 0 wt % to less than 0.05 wt %.

6. The secondary battery as claimed in claim 1, wherein the aluminum alloy has a grain size in a range of 5 to 10 μm.

7. The secondary battery as claimed in claim 1, wherein the aluminum alloy has a tensile strength in a range of 80 to 110 N/mm².

8. The secondary battery as claimed in claim 1, wherein the aluminum alloy has elongation in a range of 17 to 38%.

9. The secondary battery as claimed in claim 1, wherein the aluminum alloy is bendable up to 13 to 30 times when it is bent 180 degrees.

10. The secondary battery as claimed in claim 1, wherein the aluminum alloy has electrical conductivity in a range of 50 to 65% IACS, as defined by the international annealed copper standard (IACS).

11. The secondary battery as claimed in claim 1, wherein the aluminum alloy has resistance in a range of 68 to 85 Ω/Km.

12. The secondary battery as claimed in claim 1, wherein the first electrode tab extends outside the case.

13. The secondary battery as claimed in claim 12, wherein the case is a pouch, and the first electrode tab is attached, at a location inside of the pouch, to the first electrode plate and extends through a sealing portion of the pouch to the outside of the pouch.

14. The secondary battery as claimed in claim 12, wherein the first electrode tab serves as a terminal at an outside of the case.
